(19) United States
(12) Patent Application Publication
(10) Pub. No.: US 2008/0069998 A1
(43) Pub. Date: Mar. 20, 2008

(54) Carpet Tile

(76) Inventor: Torben Degn-Hansen, Skaeving (DK)

Correspondence Address: BROWDY AND NEIMARK, P.L.L.C.;624 NINTH STREET, NW, SUITE 300, WASHINGTON, DC, 20001-5303, US

(21) Appl. No.: 11/660,696

(22) PCT Filed: Aug. 22, 2005
(86) PCT No.: PCT/DK05/00534

§ 371 Date: Oct. 1, 2007

(30) Foreign Application Priority Data
Aug. 21, 2004 (DK) PA 2004 01268
Oct. 8, 2004 (DK) PA 2004 01136
Aug. 12, 2005 (PA) DK 2005 01136

(51) Int. Cl. B32B 3/02

(52) U.S. Cl. 428/85

(57) ABSTRACT

A carpet tile cut out from a flat-woven carpet comprising longitudinal warp threads and transverse weft threads is cut out at an angle of 45° relative to the direction of the weft threads.

The present invention relates to a carpet tile cut out from a flat-woven carpet comprising longitudinal warp threads and transverse weft threads.

Carpet tiles are manufactured from many different kinds of carpets or carpet materials: needle felt, tufted carpet or flat-woven carpet. The different carpet materials are manufactured in most different ways and have different properties. In particular needle felt and tufted carpet are materials, which have turned out to be suitable for the manufacture of carpet tiles.

Carpet materials or carpets, which are used for the manufacture of carpet tiles, usually comprise an upper textile layer and a subjacent, stabilizing layer.

Known carpet tiles from a flat-woven carpet are manufactured from a carpet comprising an upper textile layer, which is manufactured by plain weaving, in which the warp threads alternately comprise a pile yarn and a chain warp. The binder yarn or the chain warp is kept tight, whereas the pile yarn is fed in such a manner relative to the chain warp during the weaving process that the pile yarn is compressed successively for the formation of transverse ribs, which constitutes the pile of the carpet and thus the upper surface. Weft threads extend alternately in a rib and between adjacent ribs over and under the chain warp, respectively, the weft threads positioned over the chain warp being positioned at a higher level than the weft threads positioned under the chain warp. After the weaving process the underside of the woven textile is coated with glue, which penetrates into the textile close to the weft threads over the chain warp. After the coating with glue the underside of the textile is provided with a heavy, stabilizing layer of polymer, for instance polypropylene, with a filling material of iron oxide, barium carbonate, calcium carbonate and/or rock oil distillate. Moreover, glass fibre threads have been embedded in the polymeric layer for reinforcement. Finally, a thin layer of non-woven fabric is applied to the underside of the polymeric layer. The known carpet tiles are cut in the direction of the threads, i.e. along the warp threads and the weft threads, respectively. In connection with these known carpet tiles of such a flat-woven carpet, the problem has arisen that the weft thread at the edge of a tile tends to get loose and fray in case of a heavy load and/or vacuum-cleaning. Therefore, a flat-woven carpet does not seem suitable as a starting material for carpet tiles.

The problem of fraying does not arise in carpet tiles manufactured from a tufted carpet, because a tufted carpet has a solid backing, into which the pile-forming pile yarn is stuck.

It has, however, been a wish for a long time to provide a carpet tile, which is made from a flat-woven carpet, and in which the above problem is not inherent.

This has according to the invention been achieved in that the carpet tile is cut out diagonally relative to the direction of the weft threads. The carpet tile is in particular cut out by cuts extending at an angle of 45° relative to the direction of the weft threads. It has surprisingly turned out that such a carpet tile does not tend to fray at the edge.

The starting material for the carpet tile according to the invention is in principle a known carpet, in which the warp threads preferably comprise pile yarn and chain warp, and the flat-woven carpet is preferably woven in a plain weave.

In an embodiment the carpet, from which the tile is cut out, is not provided with stripes in the form of longitudinal lengths of different colours. The carpet tile may in particular be of one colour and/or evenly mixed.

The carpet tile according to the invention may be square, which generally is often the case with carpet tiles.

JP-A-7016141 discloses the manufacture of carpet tiles of more colours, by means of which carpet tiles complicated patterns may be formed. As starting material a tufted carpet is preferably used, said carpet having in a longitudinal direction wide lengths of different colours. The carpet is cut out at an angle of 45° relative to the longitudinal direction. In this way carpet tiles are obtained, which along a diagonal are divided in two halves of different colours, or carpet tiles, which has a wide central stripe along a diagonal of a different colour from that of the rest of the tile. The publication does not propose the use of a flat-woven carpet as a starting material. It would be meaningless to cut out a carpet without the longitudinal stripes, in particular one of one colour and/or evenly mixed carpet, in the manner proposed in the publication.

The invention will be explained in detail in the following by means of an example of an embodiment with reference to the appended drawings, in which

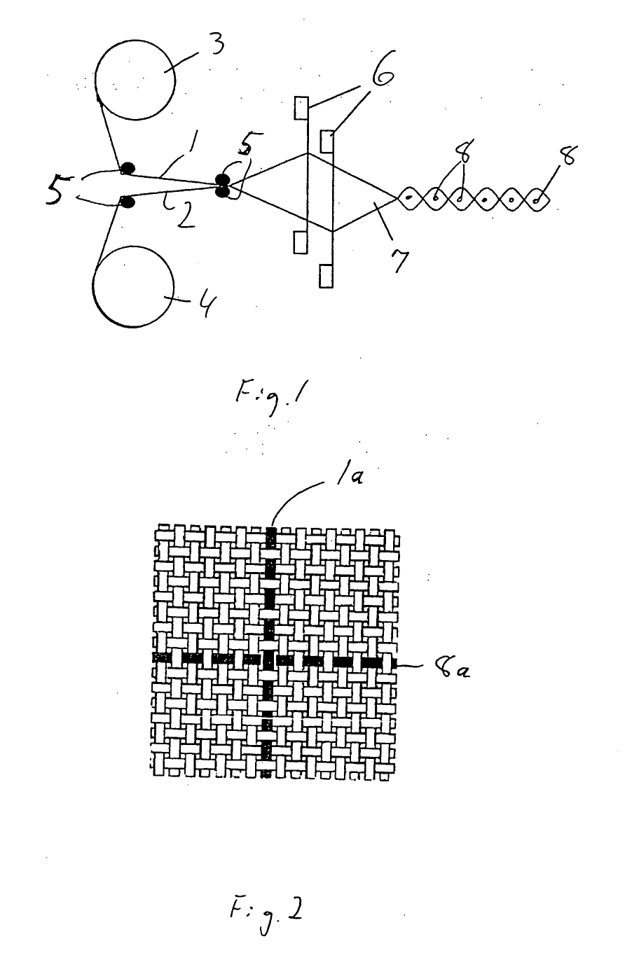

FIG. 1 schematically shows the weaving of a flat-woven carpet,

FIG. 2 schematically shows plain weaving,

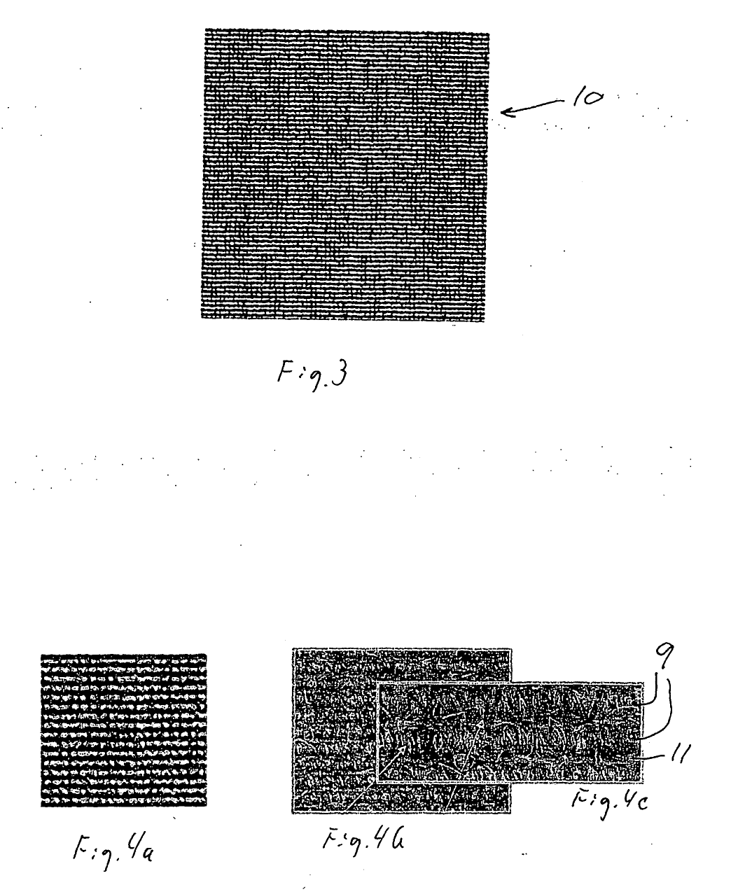

FIG. 3 shows a known carpet tile made from a flat-woven carpet,

FIGS. 4a, 4b and 4c show enlarged sections of FIG. 3,

FIG. 5 shows a carpet tile according to the invention,

FIG. 5a is an enlarged section of FIG. 5,

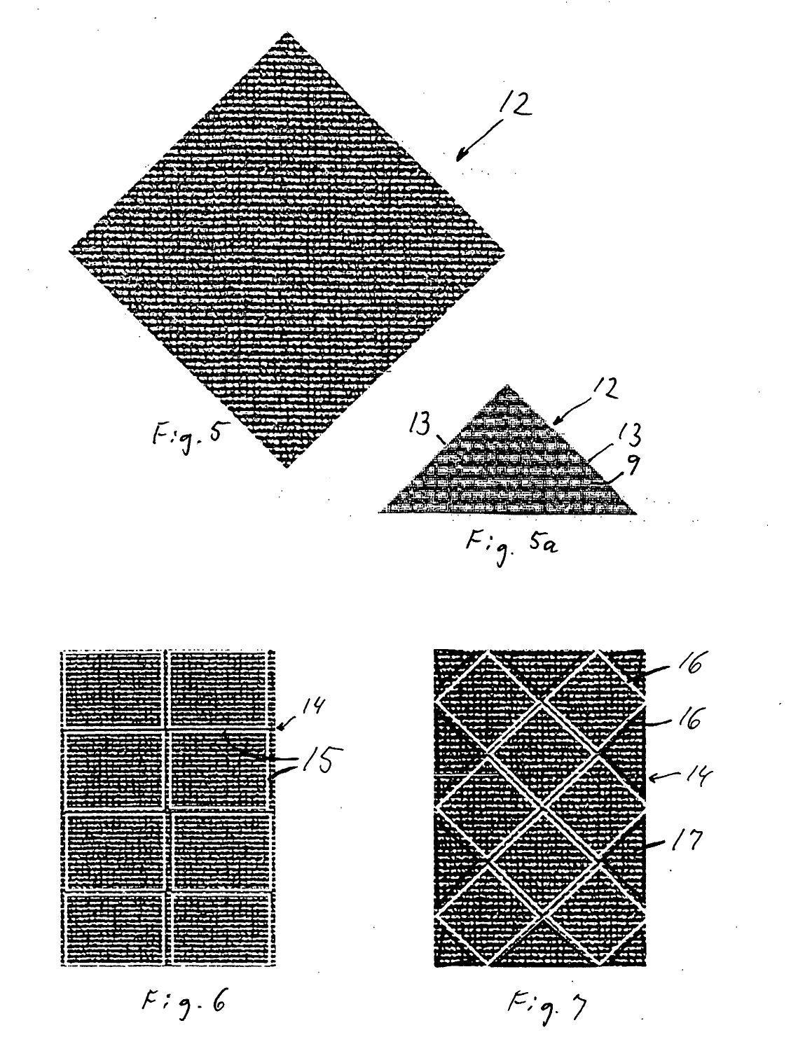

FIG. 6 shows a flat-woven carpet with a punching tool for punching carpet tiles according to prior art, and

FIG. 7 shows a flat-woven carpet with a punching tool for punching carpet tiles according to the invention.

FIG. 1 shows schematically plain weaving in accordance with prior art with warp threads comprising two different warps, namely pile yarn 1 and chain warp 2, which are each fed from their respective beams 3 and 4 and being guided over rollers 5. The two warps pass a heald system 6, by means of which the two warps 1, 2 are alternately raised and lowered reversely to one another for the formation of alternating sheds 7, in which weft threads 8 are introduced. FIG. 2 shows schematically the known plain weave provided by this method, said plain weave being characterized by the fact that both warp threads and weft threads alternately pass over and under a weft thread or a warp thread, respectively. This is in particular seen by means of the highlighted warp thread 1a and the highlighted weft thread 8a. By keeping the chain warp 2 comparatively tight and by feeding the pile yarn 1 more quickly than the chain warp is obtained that the pile yarn 1 in a manner known per se forms ribs 9 (see FIG. 4a-4c) extending transversely to the longitudinal direction of the warp threads. The weft threads may be taken through the shed 7 in any manner known per se depending on the actual loom used, for instance by means of a rack-and-pinion system, a projectile system, a pneumatic system or a shuttle system.

The upper side of a carpet manufactured by this weaving is shown in FIGS. 3-7. FIG. 3 shows a carpet tile 10 cut out from the carpet. The carpet tile is of evenly mixed colour, the pile yarn used comprising light and dark fibres. FIG. 4a is an enlarged section of the carpet tile 10, for which reason the rib structure of the surface is better seen. FIGS. 4b and 4c each show the surface of the carpet tile 10 further enlarged, the ribs 9 being even more clearly visible. Particularly in FIG. 4c ribs 9 and interspaces 11 are seen. It will be understood that inside every rib a weft thread extends hidden by the pile yarn, which forms the very rib 9. In each interspace 11 a weft thread likewise runs, which weft thread is partially visible, the weft thread running alternately over a thread of pile yarn and under a thread of chain warp.

FIG. 5 shows a carpet tile 12 according to the present invention. FIG. 5a is an enlarged section of the upper corner of the carpet tile 12 of FIG. 5. As will be seen, the carpet tile 12 is cut out in such a manner that its sides 13 extend at an angle of 45° relative to the longitudinal direction of the ribs 9 and thus also at 45° relative to the weft and warp threads.

FIG. 6 illustrates a piece of carpet, a so-called platinum, 14 with punching tools with cutting edges 15 for cutting out or punching carpet tiles according to prior art, the cuts extending in parallel with the warp and weft threads, respectively. FIG. 7 illustrates the same piece of carpet 14 with punching tools with cutting edges 16 for punching carpet tiles according to the present invention. It will be seen that the cutting edges 16 extend at 450 relative to the longitudinal direction of the ribs.

As will be seen from FIG. 7 triangular remainders 17 are formed along the edge of the platinum 14, when carpet tiles 12 are cut out according to the invention. When laying the carpet tiles 12 according to the invention in a rectangular room, the carpet tiles may be laid with its sides along the sides of the room and the ribs 9 extending diagonally in the room. Alternatively, the carpet tiles 12 may be laid with the ribs 9 in parallel with one of the sides of the room, and the remainders 17 may be used for filling the holes, which will come into being along the walls of the room.

1. A carpet tile cut out from a flat-woven carpet comprising longitudinal warp threads and transverse weft threads, the carpet tile being cut out diagonally relative to the direction of the weft threads.

2. A carpet tile according to claim 1, wherein the carpet tile is cut out by cuts extending at an angle of 45° relative to the direction of the weft threads.

3. A carpet tile according to claim 1, wherein the warp threads comprise pile yarn and chain warp.

4. A carpet tile according to claim 1, wherein the flat-woven carpet is woven in a plain weave.

5. A carpet tile according to claim 1, wherein the carpet, from which the tile is cut out, is not provided with stripes in the form of longitudinal lengths of different colours.

6. A carpet tile according to claim 1, said carpet tile being of one colour.

7. A carpet tile according to claim 1, said carpet tile being square.

8. A carpet tile according to claim 1, said carpet tile being of an evenly mixed colour.

9. A carpet tile according to claim 2, wherein the warp threads comprise pile yarn and chain warp.

10. A carpet tile according to claim 2, wherein the flat-woven carpet is woven in a plain weave.

11. A carpet tile according to claim 2, wherein the carpet, from which the tile is cut out, is not provided with stripes in the form of longitudinal lengths of different colours.

12. A carpet tile according to claim 2, said carpet tile being of one colour.

13. A carpet tile according to claim 2, said carpet tile being square.

14. A carpet tile according to claim 2, said carpet tile being of an evenly mixed colour.
